(19) United States
(12) Patent Application Publication
(10) Pub. No.: US 2021/0230066 A1
(43) Pub. Date: Jul. 29, 2021

(54) GYPSUM PANELS, SYSTEMS, AND METHODS

(71) Applicant: Georgia-Pacific Gypsum LLC, Atlanta, GA (US)

(72) Inventor: Vincent B. THOMAS, Bogart, GA (US)

(21) Appl. No.: 17/056,079

(22) PCT Filed: May 8, 2019
(86) PCT No.: PCT/US19/31262

§ 371 Date: Nov. 17, 2020

Related U.S. Application Data
(60) Provisional application No. 62/673,651, filed on May 18, 2018.

(51) Int. Cl. C04B 28/14; C04B 41/00; C04B 41/63; C04B 14/28; C04B 41/48; E04C 2/04

(52) U.S. Cl. CPC C04B 28/14; C04B 41/009; C04B 41/63; C04B 2111/00629; C04B 41/483; E04C 2/043; C04B 14/28

(57) ABSTRACT

Gypsum panels and methods of making the same are provided herein. The gypsum panels include a barrier coating on a second surface of a coated fiberglass mat, the second surface comprising a coated surface, with the barrier coating comprising an acrylic binder and a filler in an amount of from about 50 to about 75 percent solids by volume of the barrier coating, the barrier coating being deposited in an amount of from about 46 lb/msf to about 60 lb/msf, dry weight. Sheathing systems of at least two such gypsum panels are also provided.

### CROSS-REFERENCE TO RELATED APPLICATIONS

This application claims priority benefit of International Application No. PCT/US2019/031262 filed May 8, 2019, which claims priority to U.S. Provisional Application No. 62/673,651, filed May 18, 2018, the disclosures of which are incorporated by reference herein.

### BACKGROUND

The present invention relates generally to the field of panels for use in building construction, and more particularly to gypsum panels and methods of making gypsum panels.

Typical building panels, or building sheathing, include a core material, such as gypsum, and a mat facer, such as a fiberglass mat facer. During manufacturing, the gypsum core material is traditionally applied as a slurry to a surface of the mat facer and allowed to set, such that the mat facer and gypsum core are adhered at the interface. Often, such panels suffer from water intrusion and other performance issues.

For example, poor slurry infiltration at the mat facer may lead to increased porosity of the panel, resulting in increased water penetration and decreased weathering performance. Thus, such panels may not meet building code requirements for air and water penetration. Indeed, many modern building codes require the use of barriers in construction to protect the building from air and water penetration. For example, building codes in eastern Canada and the northeastern United States now require air barriers to be used in all construction. Moreover, the existing International Building Code/International Residential Code (IBC/IRC) requires the use of a water resistive air barrier for all new construction. Common water-resistive air barriers are formed from a variety of materials and structures and applied to the surface of sheathing panels (e.g., gypsum panels, oriented strand board panels).

Traditionally, three types of water resistive air barriers may be used to meet building codes. First, fabric type membranes, or “wraps,” may be used to cover the surface of building sheathing panels. However, these fabric wraps are typically unable to withstand wind conditions, suffer from drooping, and are difficult to install at heights. Moreover, the standard method of attaching such fabric membranes to sheathing panels is stapling, which compromises the effectiveness of the membrane as an air or water barrier. Second, a liquid coating water resistive air barrier membrane may be applied to sheathing panels. However, these liquid coatings must be applied in the field by qualified contractors, which is time intensive and costly. Moreover, although liquid coatings serve as effective an water barrier, they provide low water vapor permeance, which affects the wall's ability to dry should it get wet during service (e.g., around window penetrations, flashing). Third, self-adhered, or “peel and stick,” water resistive air barrier membranes may be applied to sheathing panels. However, these self-adhered membranes are generally not permeable and therefore are not an option in many projects, because the architect or engineer must account for this impermeability in designing the building, to prevent the potential for moisture being trapped inside the wall cavity. Furthermore, self-adhered membranes require the sheathing panels to be dry and often primed prior to application, which significantly slows down the construction process.

Accordingly, it would be desirable to provide panels having improved water-resistive properties.

### SUMMARY

In one aspect, methods of making a gypsum panel are provided, including: (i) depositing a first gypsum slurry onto a first surface of a first coated fiberglass mat; (ii) setting the first gypsum slurry to form at least a portion of a gypsum core of a gypsum panel; and (iii) depositing a barrier coating onto a second surface of the first coated fiberglass mat, the second surface comprising a coated surface, the barrier coating comprising an acrylic binder and a filler in an amount of from about 50 to about 75 percent solids by volume of the barrier coating, the barrier coating being deposited in an amount of from about 46 lb/msf to about 60 lb/msf, dry weight, wherein the gypsum panel displays a vapor permeance of between 0.1 perm and 1 perm, when measured according to ASTM E96.

In another aspect, gypsum panels are provided, including: (i) a gypsum core having a first surface and a second opposed surface; (ii) a first coated fiberglass mat associated with the first surface of the gypsum core; and (iii) a barrier coating disposed on the first coated fiberglass mat, the barrier coating comprising an acrylic binder and a filler in an amount of from about 50 to about 75 percent solids by volume of the barrier coating, the barrier coating being deposited in an amount of from about 46 lb/msf to about 60 lb/msf, dry weight, wherein the gypsum panel displays a vapor permeance of between 0.1 perm and 1 perm, when measured according to ASTM E96.

In yet another aspect, building sheathing systems are provided, including at least two gypsum panels as described herein and a seaming component configured to provide a seam at an interface between the at least two gypsum panels, wherein the system displays a vapor permeance of between 0.1 perm and 1 perm, when measured according to ASTM E96, in the absence of any externally applied barrier product.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a cross-sectional view of a fiberglass faced gypsum panel having a barrier coating.

FIG. 2 is a cross-sectional view of a fiberglass faced gypsum panel having a barrier coating.

FIG. 3 is a cross-sectional view of a fiberglass faced gypsum panel having a barrier coating.

FIG. 4 is a perspective view of a building sheathing system.

FIG. 5A is a side view of an experimental apparatus used for a hydrostatic head test in accordance with AATCC 127-2008.

FIG. 5B is a top view of an experimental apparatus used for a hydrostatic head test in accordance with AATCC 127-2008.

FIG. 6 is a graph of permeance versus coating weight of various sample boards tested in the Examples.

### DETAILED DESCRIPTION

Improved water repelling, or water-resistive, gypsum panels have been developed, along with associated methods for their manufacture. In certain embodiments, the panels have a secondary barrier coating having a high filler load and increased coating weight, which have been found to provide a class II vapor permeance (i.e., semi-impermeability), according to the ASTM E96 test method, to the panel. These panels provide advantages over commercially available gypsum panels. For example, such panels beneficially may enhance the building product performance characteristics such as water repellence, moisture migration, fire resistance, IR reflectivity, conductivity, UV resistance, freeze thaw durability, and other weather related properties.

As used herein, the term “water-resistive barrier” refers to the ability of a panel or system to resist liquid or bulk water from penetrating, leaking, or seeping past the sheathing and into the surrounding wall components while also providing water vapor transmission, or permeance, that is high enough to allow any moisture that does develop in the wall to escape. Combined with flashing around openings, such water-resistive barriers may create a shingled effect to direct water away from the sheathing and surrounding wall components. As used herein, the term “air barrier” refers to the ability of a panel or system to resist the movement of air into (infiltration) and out of (exfiltration) conditioned spaces, to create a more energy efficient structure. As used herein, the term “water-resistive air barrier” refers to the ability of a panel or system to display both water-resistive barrier and air barrier properties.

Gypsum sheathing panels or boards may contain a set gypsum core sandwiched between two fibrous glass mats, one or both of which may be coated. The mat coating may be a substantially continuous barrier coating. As used herein, the term “substantially continuous barrier coating” refers to a coating material that is substantially uninterrupted over the surface of the fibrous mat.

During manufacturing, a gypsum slurry may be deposited on the uncoated surface of the coated fiberglass mat (which may be pre-coated offline or online) and set to form a gypsum core of the panel. The gypsum slurry may penetrate some portion of the thickness of the fiberglass mat and provide a mechanical bond for the panel. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core.

Traditional gypsum sheathing panels do not consistently pass industry standard bulk water holdout tests and therefore are typically covered with commercially available water-resistive air barriers (e.g., mechanically attached flexible sheets, self-adhered sheets, fluid-applied membranes or coatings, sprayed foams). As such, the present disclosure is directed to providing gypsum panels and sheathing systems that provide an effective water-resistive air barrier meeting class II Vapor Perm (as measured according to ASTM E96), water penetration barrier (as measured according to ASTM E331, AATCC 127 modified per AC 212 Section 4.8.3) and/or air barrier (as measured according to ASTM E2357 and CAN S742). As referred to herein, ASTM E96 (as last revised in 2016), may involve Method A (known as the desiccant method or the dry cup method) and/or Method B (known as the wet cup method).

Such improved sheathing panels may be combined with seaming components (i.e., components that treat the joints, or seams, between panels) to greatly reduce the cost, time, and complexity of installation of a water-resistive air barrier that provides the desired resistance to bulk water.

While this disclosure is generally directed to gypsum panels, it should be understood that other cementitious panel core materials are also intended to fall within the scope of the present disclosure. For example, cementitious panel core materials such as those including magnesium oxide or aluminosilicate may be substituted for the gypsum of the embodiments disclosed herein, to achieve similar results.

Moreover, while embodiments of the present disclosure are described generally with reference to fiberglass mats, it should be understood that other mat materials, including other fibrous mat materials, may also be used in the present panels. In certain embodiments, the nonwoven fibrous mat is formed of fiber material that is capable of forming a strong bond with the material of the building panel core through a mechanical-like interlocking between the interstices of the fibrous mat and portions of the core material. Examples of fiber materials for use in the nonwoven mats include mineral-type materials such as glass fibers, synthetic resin fibers, and mixtures or blends thereof. Both chopped strands and continuous strands may be used.

Various embodiments of this disclosure are for purposes of illustration only. Parameters of different steps, components, and features of the embodiments are described separately, but may be combined consistently with this description of claims, to enable other embodiments as well to be understood by those skilled in the art. Various terms used herein are likewise defined in the description, which follows.

### Panels and Systems

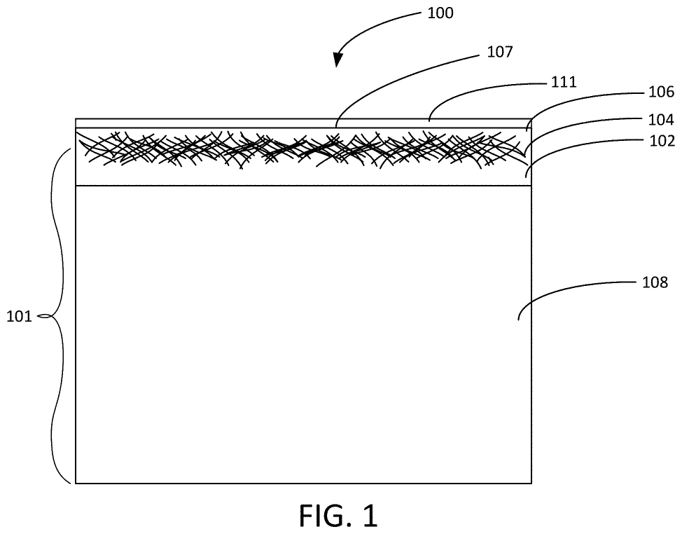

In certain embodiments, as shown in FIG. 1, a gypsum panel 100 includes a gypsum core 101 having a first surface and a second opposed surface, and a first fiberglass mat 104 associated with the first surface of the gypsum core 101, such that gypsum of the gypsum core penetrates at least a portion of the first fiberglass mat 104. The various layers are illustrated as separate layers in the figures for ease of illustration; however, it should be understood that overlap of these materials may occur at their interfaces.

In certain embodiments, the gypsum panel 100 includes a set gypsum core 101 associated with a first surface of first fiberglass mat 104 and a mat coating 106 applied to a second surface of the first fiberglass mat 104. The mat coating may have a dry weight of from about 1 pound to about 25 pounds per thousand square feet (lb/msf) of board surface, such as less than 15 pounds per thousand square feet. As discussed above, the mat coating may be substantially continuous, such that it covers at least 99 percent of the board surface, or at least 99.9 percent of the mat surface.

Suitable coating materials (i.e., the precursor to the dried mat coating) contain at least one suitable polymer binder. Suitable polymer binders may be selected from polymeric emulsions and resins, e.g. acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the polymer binder is an acrylic latex or a polystyrene latex. In some embodiments, the polymer binder is hydrophobic. In certain embodiments, the binder includes UV curable monomers and/or polymers (e.g. epoxy acrylate, urethane acrylate, polyester acrylate). In certain embodiments, the mat coating contains the polymer binder in an amount of from about 5 percent to about 75 percent, by weight, on a dry basis.

Examples of suitable polymer binders that may be used in the continuous barrier coatings described herein include SNAP 720, commercially available from Arkema Coating Resins, which is a structured nano-particle acrylic polymer containing 100% acrylic latex and 49% solids by weight, with a 0.08 micron particle size; SNAP 728, commercially available from Arkema Coating Resins, which is a structured nano-acrylic polymer containing 100% acrylic latex and 49% solids by weight, with a 0.1 micron particle size; and NEOCAR 820, commercially available from Arkema Coating Reins, which is a hydrophobic modified acrylic latex containing 45% solids by weight, with a 0.07 micron particle size.

In certain embodiments, the mat coating also contains one or more inorganic fillers. For example, the inorganic filler may be calcium carbonate or another suitable filler known in the industry. In certain embodiments, the filler is an inorganic mineral filler, such as ground limestone (calcium carbonate), clay, mica, gypsum (calcium sulfate dihydrate), aluminum trihydrate (ATH), antimony oxide, sodium-potassium alumina silicates, pyrophyllite, microcrystalline silica, and talc (magnesium silicate). In certain embodiments, the filler may inherently contain a naturally occurring inorganic adhesive binder. For example, the filler may be limestone containing quicklime (CaO), clay containing calcium silicate, sand containing calcium silicate, aluminum trihydrate containing aluminum hydroxide, cementitious fly ash, or magnesium oxide containing either the sulfate or chloride of magnesium, or both. In certain embodiments, the filler may include an inorganic adhesive binder as a constituent, cure by hydration, and act as a flame suppressant. For example, the filler may be aluminum trihydrate (ATH), calcium sulfate (gypsum), and the oxychloride and oxysulfate of magnesium. For example, fillers may include MINEX 7, commercially available from the Cary Company (Addison, Ill.); IMSIL A-10, commercially available from the Cary Company; and TALCRON MP 44-26, commercially available from Specialty Minerals Inc. (Dillon, Mont.). The filler may be in a particulate form. For example, the filler may have a particle size such that at least 95% of the particles pass through a 100 mesh wire screen.

In certain embodiments, the precursor material that forms the mat coating also contains water. For example, the coating material may contain the polymer binder in an amount of from about 35 percent to about 80 percent, by weight, and water in an amount of from about 20 percent to about 30 percent, by weight. In embodiments containing the filler, the continuous barrier coating material may also contain an inorganic filler in an amount of from about 35 percent to about 80 percent, by weight. In some embodiments, the polymer binder and the inorganic filler are present in amounts of within 5 percent, by weight, of each other. For example, the polymer binder and filler may be present in a ratio of approximately 1:1.

In some embodiments, the mat coating also includes water and/or other optional ingredients such as colorants (e.g., dyes or pigments), transfer agents, thickeners or rheological control agents, surfactants, ammonia compositions, defoamers, dispersants, biocides, UV absorbers, and preservatives. Thickeners may include hydroxyethyl cellulose; hydrophobically modified ethylene oxide urethane; processed attapulgite, a hydrated magnesium aluminosilicate; and other thickeners known to those of ordinary skill in the art. For example, thickeners may include CELLOSIZE QP-09-L and ACRYSOL RM-2020NPR, commercially available from Dow Chemical Company (Philadelphia, Pa.); and ATTAGEL 50, commercially available from BASF Corporation (Florham Park, N.J.). Surfactants may include sodium polyacrylate dispersants, ethoxylated nonionic compounds, and other surfactants known to those of ordinary skill in the art. For example, surfactants may include HYDROPALAT 44, commercially available from BASF Corporation; and DYNOL 607, commercially available from Air Products (Allentown, Pa.). Defoamers may include multi-hydrophobe blend defoamers and other defoamers known to those of ordinary skill in the art. For example, defoamers may include FOAMASTER SA-3, commercially available from BASF Corporation. Ammonia compositions may include ammonium hydroxide, for example, AQUA AMMONIA 26 BE, commercially available from Tanner Industries, Inc. (Southampton, Pa.). Biocides may include broad-spectrum microbicides that prohibit bacteria and fungi growth, antimicrobials such as those based on the active diiodomethyl-ptolylsulfone, and other compounds known to those of ordinary skill in the art. For example, biocides may include KATHON LX 1.5%, commercially available from Dow Chemical Company, POLYPHASE 663, commercially available from Troy Corporation (Newark, N.J.), and AMICAL Flowable, commercially available from Dow Chemical Company. Biocides may also act as preservatives. UV absorbers may include encapsulated hydroxyphenyl-triazine compositions and other compounds known to those of ordinary skill in the art, for example, TINUVIN 477DW, commercially available from BASF Corporation. Transfer agents such as polyvinyl alcohol (PVA) and other compounds known to those of ordinary skill in the art may also be included in the coating composition.

In some embodiments, as shown in FIG. 1, the gypsum of the gypsum core 101 penetrates a remaining portion of the first fiberglass mat 104 such that voids in the first fiberglass mat 104 are substantially eliminated and the water resistance of the panel 100 is further enhanced. For example, in one embodiment, the first fiberglass mat 104 has a mat coating 106 on a surface opposite the gypsum core 101, the mat coating 106 penetrating a portion of the first fiberglass mat 104, to define the remaining portion of the first fiberglass mat 104. That is, gypsum of the gypsum core 101 may penetrate a remaining fibrous portion of the first fiberglass mat 104 such that voids in the first fiberglass mat 104 are substantially eliminated.

As used herein the phrase “such that voids in the fiberglass mat are substantially eliminated” and similar phrases, refer to the gypsum slurry, and thus the set gypsum, of the gypsum core filling all or nearly all of the interstitial volume of the fiberglass mat that is not filled by the coating material. In certain embodiments, the gypsum of the gypsum core fills at least 95 percent of the available interstitial volume of the coated fiberglass mat. In some embodiments, the gypsum core fills at least 98 percent of the available interstitial volume of the coated fiberglass mat. In further embodiments, the gypsum core fills at least 99 percent of the available interstitial volume of the coated fiberglass mat. Such panels, in which the gypsum penetrates the mat such that the voids in the mat are substantially eliminated, may be manufactured via a variety of methods, as discussed in more detail herein. For example, the gypsum that contacts the non-coated surface of the fiberglass mat may be hydrophobic or otherwise chemically modified for improved mat penetration, and/or mechanical means may be used to enhance penetration of the gypsum slurry into the mat.

By maximizing gypsum slurry penetration into the side of the fiberglass mat receiving gypsum, the movement of water under the mat coating within the glass mat of the finished panel when exposed to bulk water head pressures may be substantially and adequately reduced, without significantly altering the water vapor transmission rate (i.e., the ability to dry) of the finished panel. Thus, the gypsum panels disclosed herein may have one or more improved water-resistive barrier properties.

In embodiments of the disclosure, the gypsum panel includes a barrier coating that is distinct from, and provided in addition to, the mat coating discussed above. That is, as shown in FIG. 1, the gypsum panels 100 described herein include a barrier coating 111 deposited on mat coating 106. It has been discovered that providing the barrier coating in addition to the mat coating, in the composition and amounts described herein, surprisingly provides improved water-resistive air barrier properties to the panel, such as class II vapor permeance (i.e., semi-impermeability), as measured according to the ASTM E96 test method. In comparison to commercially available panels, the presently described panels provide a lower vapor permeance, in the range of between 0.1 perm and 1 perm, when measured according to ASTM E96.

In certain embodiments, the barrier coating 111 contains an acrylic binder and a filler in an amount of from about 50 to about 75 percent solids by volume of the barrier coating. For example, the acrylic binder may be any of the acrylic-containing binders discussed above in reference to the mat coating.

In certain embodiments, the barrier coating contains a relatively high amount of filler. For example, the barrier coating the barrier coating may contain the filler in an amount of from about 50 to about 75 percent solids by volume, such as from about 60 to about 70 percent solids by volume, from about 62 to about 66 percent solids by volume, or about 64 percent solids by volume. For example, the barrier coating may contain the filler in an amount of from about 65 percent to about 90 percent solids by weight of the barrier coating, such as from about 70 percent to about 85 percent solids by weight of the barrier coating, from about 75 to about 81 percent solids by weight of the barrier coating, or about 78 percent solids by weight of the barrier coating.

In certain embodiments, the barrier coating is deposited in a relatively increased amount, as compared to commercially available gypsum panels. Without intending to be bound by a particular theory, it is believed that the increased amount/weight of the barrier coating, in combination with the coating being highly filled, results in a decrease in permeance, when the barrier coating is applied as a secondary coating to a pre-coated fiberglass mat. In some embodiments, the barrier coating is deposited in an amount of greater than about 46 lb/msf, such as from about 46 lb/msf to about 60 lb/msf, dry weight. For example, the barrier coating may be deposited in an amount of from about 46 lb/msf to about 58 lb/msf, from about 48 lb/msf to about 60 lb/msf from about 46 lb/msf to about 48 lb/msf, or greater than about 48 lb/msf.

In certain embodiments, the barrier coating has a weight of from about 13 to about 14 lbs/gallon, such as about 13.4 lbs/gallon. In certain embodiments, the barrier coating has a viscosity of about 10,000 to about 14,000 cps, as measured on a Brookfield spindle #5 at 50 rpm, such as a viscosity of about 12,000 cps, as measured on a Brookfield spindle #5 at 50 rpm. In certain embodiments, the barrier coating has a pH of about 8.5.

The filler for the barrier coating may be selected from any of the fillers described above with reference to the mat coating, such as calcium carbonate.

Thus, the present disclosure relates to gypsum panels having a coated fiberglass mat facing and a secondary highly filled acrylic coating present in an amount of at least about 46 lb/msf. As will be explained in the Examples below, such panels unexpectedly were found to achieve a class II vapor permeance (i.e., a consistent permeance of between 0.1 and 1.0) as compared to typical panels having a lower amount of coating (i.e., less than about 45 lb/msf), which display a vapor permeance of greater than 1.0.

In certain embodiments, the mat 104 is a nonwoven fiberglass mat. For example, the glass fibers may have an average diameter of from about 10 to about 17 microns and an average length of from about ¼ inch to about 1 inch. For example, the glass fibers may have an average diameter of 13 microns (i.e., K fibers) and an average length of ¾ inch. In certain embodiments, the non-woven fiberglass mats have a basis weight of from about 1.5 pounds to about 3.5 pounds per 100 square feet of the mat. The mats may each have a thickness of from about 20 mils to about 35 mils. The fibers may be bonded together to form a unitary mat structure by a suitable adhesive. For example, the adhesive may be a urea-formaldehyde resin adhesive, optionally modified with a thermoplastic extender or cross-linker, such as an acrylic cross-linker, or an acrylate adhesive resin.

In certain embodiments, as shown in FIG. 1, the gypsum core 101 includes two or more gypsum layers 102, 108. For example, the gypsum core may include various gypsum layers having different compositions. In some embodiments, the first gypsum layer 102 that is in contact with the fiberglass mat 104 (i.e., the layer that forms an interface with the coating material 106 and at least partially penetrates the remaining fibrous portion of the first fiberglass mat) is a slate coat layer. In some embodiments, the first gypsum layer 102 is present in an amount from about 5 percent to about 20 percent, by weight, of the gypsum core 101. The various gypsum layers are shown as separate layers in the figures for ease of illustration; however, it should be understood that overlap of these materials may occur at their interfaces.

In some embodiments, the slurry that forms the gypsum layer having an interface with the barrier coating includes a wetting agent to facilitate penetration of the slurry into the fibrous mat. This slurry may form the entire gypsum core or may form one or more layers of the gypsum core. That is, one or more layers forming the gypsum core may contain the wetting agent. As discussed in more detail below, the wetting agent may be any agent that reduces the surface tension of the slurry. In certain embodiments, the first gypsum layer includes a wetting agent in an amount effective to bring a slurry surface tension of the first gypsum layer to 65 dyne/cm or less. In certain embodiments, the first gypsum layer includes a wetting agent in an amount effective to bring a slurry surface tension of the first gypsum layer to 60 dyne/cm or less. In certain embodiments, the first gypsum layer includes a wetting agent in an amount effective to bring a slurry surface tension of the first gypsum layer to 55 dyne/cm or less. In certain embodiments, the first gypsum layer includes a wetting agent in an amount effective to bring a slurry surface tension of the first gypsum layer to from about 30 dyne/cm to about 60 dyne/cm. In certain embodiments, the first gypsum layer includes a wetting agent in an amount effective to bring a slurry surface tension of the first gypsum layer to from about 40 dyne/cm to about 60 dyne/cm. In certain embodiments, the first gypsum layer includes a polymer binder or an inorganic binder in an amount of from about 0.5 lb/1000 ft2 to about 50 lb/1000 ft2, in the set gypsum layer. In certain embodiments, the first gypsum layer includes a polymer binder or an inorganic binder in an amount of from about 0.5 lb/1000 ft2 to about 15 lb/1000 ft2, in the set gypsum layer. In some embodiments, the first gypsum layer has a wet density of from about 88 pcf to about 98 pcf. In some embodiments, the first gypsum layer has a wet density of from about 93 pcf to about 96 pcf.

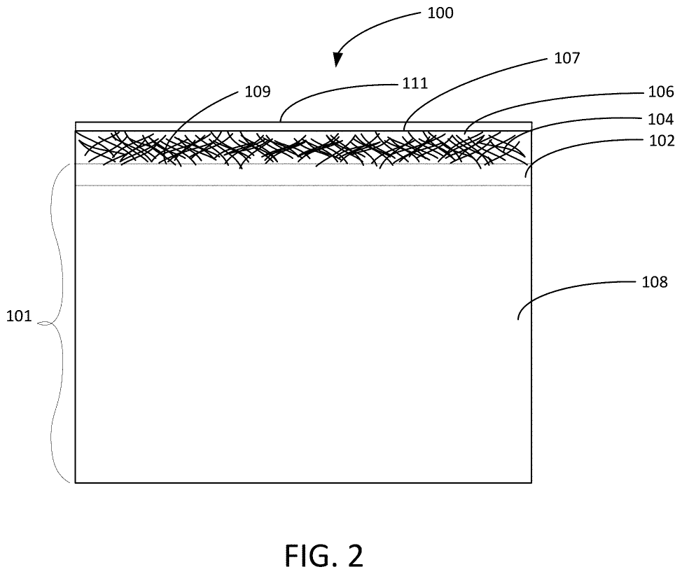

In certain embodiments, as shown in FIG. 2, penetration of the gypsum slurry into the fibrous mat is encouraged with a polymer binder coating or an inorganic binder coating 109 on a surface of the first fiberglass mat 104 that contacts the gypsum core 101. In some embodiments, the mat coating comprises a wetting agent in an amount effective to bring a wet surface tension of the coating to 60 dyne/cm or less. In some embodiments, the mat coating comprises a wetting agent in an amount effective to bring a wet surface tension of the coating to from about 30 dyne/cm to about 60 dyne/cm. In some embodiments, the mat coating comprises a wetting agent in an amount effective to bring a wet surface tension of the coating to from about 40 dyne/cm to about 60 dyne/cm.

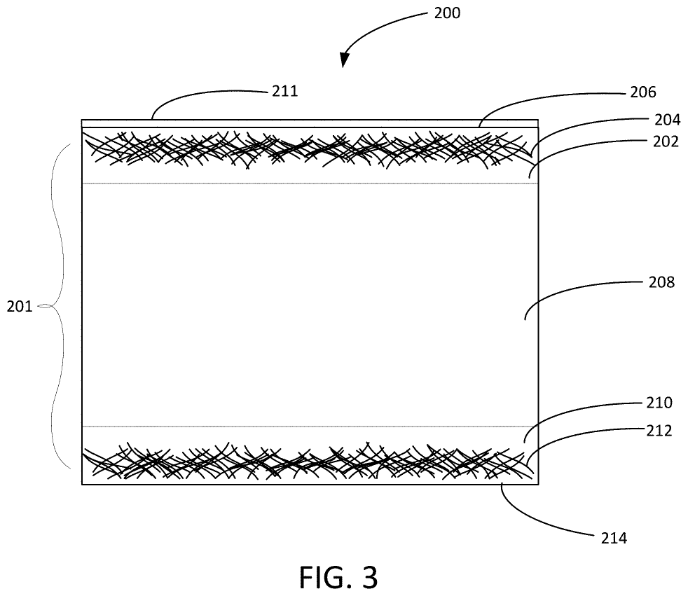

In certain embodiments, as shown in FIG. 3, a gypsum panel 200 includes two fiberglass mats 204, 212 that are associated with the gypsum core 201. The second fiberglass mat 212 is present on a face of the gypsum core 201 opposite the first fiberglass mat 204. In some embodiments, only the first fiberglass mat 204 has a mat coating 206 on a surface thereof. In other embodiments, both fiberglass mats 204, 212 have a coating 206, 214 on a surface thereof opposite the gypsum core 201. In some embodiments, the gypsum core 201 includes three gypsum layers 202, 208, 210. One or both of the gypsum layers 202, 210 that are in contact with the fiberglass mats 204, 212 may be a slate coat layer. In certain embodiments, one or both of the gypsum layers 202, 210 that are in contact with the fiberglass mats 204, 212 may be a slate coat layer with hydrophobic characteristics and/or a wet density of from about 88 pcf to about 98 pcf, or of from about 93 pcf to about 96 pcf.

The layers of the gypsum core may be similar to gypsum cores used in other gypsum products, such as gypsum wallboard, dry wall, gypsum board, gypsum lath, and gypsum sheathing. For example, the gypsum core may be formed by mixing water with powdered anhydrous calcium sulfate or calcium sulfate hemihydrate, also known as calcined gypsum, to form an aqueous gypsum slurry, and thereafter allowing the slurry mixture to hydrate or set into calcium sulfate dihydrate, a relatively hard material. In certain embodiments, the gypsum core includes about 80 weight percent or above of set gypsum (i.e., fully hydrated calcium sulfate). For example, the gypsum core may include about 85 weight percent set gypsum. In some embodiments, the gypsum core includes about 95 weight percent set gypsum. The gypsum core may also include a variety of additives, such as accelerators, set retarders, foaming agents, and dispersing agents.

In certain embodiments, one or more layers of the gypsum core also include reinforcing fibers, such as chopped glass fibers. For example, the gypsum core, or any layer(s) thereof, may include up to about 0.6 pounds of reinforcing fibers per 100 square feet of panel. For example, the gypsum core, or a layer thereof, may include about 0.3 pounds of reinforcing fibers per 100 square feet of panel. The reinforcing fibers may have a diameter between about 10 and about 17 microns and have a length between about 6.35 and about 12.7 millimeters.

The gypsum core, or one or more layers thereof, such as one or more slate coat layers, may also include an additive that improves the water-resistant properties of the core. Such additives may include, for example, poly(vinyl alcohol), optionally including a minor amount of poly(vinyl acetate); metallic resinates; wax, asphalt, or mixtures thereof, for example as an emulsion; a mixture of wax and/or asphalt and cornflower and potassium permanganate; water insoluble thermoplastic organic materials such as petroleum and natural asphalt, coal tar, and thermoplastic synthetic resins such as poly(vinyl acetate), poly(vinyl chloride), and a copolymer of vinyl acetate and vinyl chloride, and acrylic resins; a mixture of metal rosin soap, a water soluble alkaline earth metal salt, and residual fuel oil; a mixture of petroleum wax in the form of an emulsion and either residual fuel oil, pine tar, or coal tar; a mixture of residual fuel oil and rosin; aromatic isocyanates and diisocyanates; organopolysiloxanes; siliconates; wax emulsions, including paraffin, microcrystalline, polyethylene, and various co-emulsified wax emulsions; wax asphalt emulsion, each optionally with potassium sulfate, alkali, or alkaline earth aluminates, and Portland cement; a wax-asphalt emulsion prepared by adding to a blend of molten wax and asphalt, an oil-soluble, water-dispersing emulsifying agent, and admixing the aforementioned with a solution of case including, as a dispersing agent, an alkali sulfonate of a polyarylmethylene condensation product. Mixtures of these water-resistance additives may also be employed. For example, a mixture of two or more of: poly(vinyl alcohol), siliconates, wax emulsion, and wax-asphalt emulsion of the aforementioned types, may be used to improve the water resistance of the gypsum core, or gypsum slate coat layer(s) thereof.

The gypsum core, or one or more layers thereof, may also include one or more additives that enhance the inherent fire resistance of the gypsum core. Such additives may include chopped glass fibers, other inorganic fibers, vermiculite, clay, Portland cement, and other silicates, among others.

In certain embodiments, the panels have a thickness from about ¼ inch to about 1 inch. For example, the panels may have a thickness of from about ½ inch to about ⅝ inch.

In certain embodiments, as discussed above, the building panels described herein may display one or more improved performance characteristics such as water repellence, moisture migration, fire resistance, IR reflectivity, conductivity, UV resistance, freeze thaw durability, and other weather related properties. As a protective barrier, the thin film coating may reduce surface abrasion, dusting, abrasiveness, or itchiness from the panel facing materials. As a water-resistive barrier, the coating may resist water penetration under certain hydrostatic pressure. In some embodiments, the building panel displays an HHT passing rate of at least 90 percent, as measured according to AATCC 127-2008 and/or AC 212. In certain embodiments, the building panel displays a column water loss of less than 0.25 inch, as measured according to AATCC 127-2008 and/or AC 212. In certain embodiments, the gypsum panel displays a water gain of less than 0.5 percent, as measured according to AATCC 127-2008 and/or AC 212.

In certain embodiments, the gypsum panel passes a hydrostatic head test against water leakage, as measured by AATCC 127-2008. In addition to hydrostatic head pressure tests, other similar tests can be used to assess bulk water resistance in the range of 0.32 inches water (1.67 psf) to 44 inches of water head pressure (228 psf). This may include but is not limited to other water head tests (such as ASTM E2140), water ponding tests, cobb tests (such as ASTM C473, ASTM D3285, ASTM D5795, ASTM D7433, ASTM D7281), or a chambered test aided by vacuum or negative pressure differentials. Thus, the gypsum panels described herein may pass any combination of the foregoing tests.

In certain embodiments, the gypsum panel displays an air penetration resistance of 0.02 L/sm2 at 75 Pa, or less, when measured according to ASTM E2178. In certain embodiments, the gypsum panel displays an air penetration resistance of 0.02 L/sm2 at 300 Pa, or less, when measured according to ASTM E2178.

In certain embodiments, the gypsum panel is fire resistant. In certain embodiments, the gypsum panel is classified as noncombustible when tested in accordance with ASTM E136 or CAN/ULC S114 and complies with ASTM C1177 requirements for glass mat gypsum substrates designed to be used as exterior or sheathing for water barriers. In particular, a ⅝ inch panel may have increased fire resistance over other sheathing substrates, such as cellulosic-based sheathing. In some embodiments, the gypsum panel has a “Type X” designation, when measured according to ASTM E119. The gypsum panels may meet “Type X” designation when tested in accordance with ASTM E119 fire tests for both generic (Generic systems in the GA-600 Fire Resistance Design Manual) and proprietary building assembly wall designs. ASTM E119 is designed to test the duration for which a building assembly can contain a fire and retain structural integrity under a controlled fire with a standard time/temperatures curve. In certain embodiments, the gypsum panel has a level 0 flame spread index and smoke develop index, when measured according to ASTM E84. For example, when exposed to surface burning characteristics, per ASTM E84 or CAN/ULC-5102, the flame spread index and smoke develop index for the gypsum panel may be 0.

Building sheathing systems are also provided herein, and include at least two of the improved water-resistive air barrier gypsum panels described herein, including any features, or combinations of features, of the panels described herein. For example, the gypsum panels may each include a gypsum core associated with a first fiberglass mat having a mat coating.

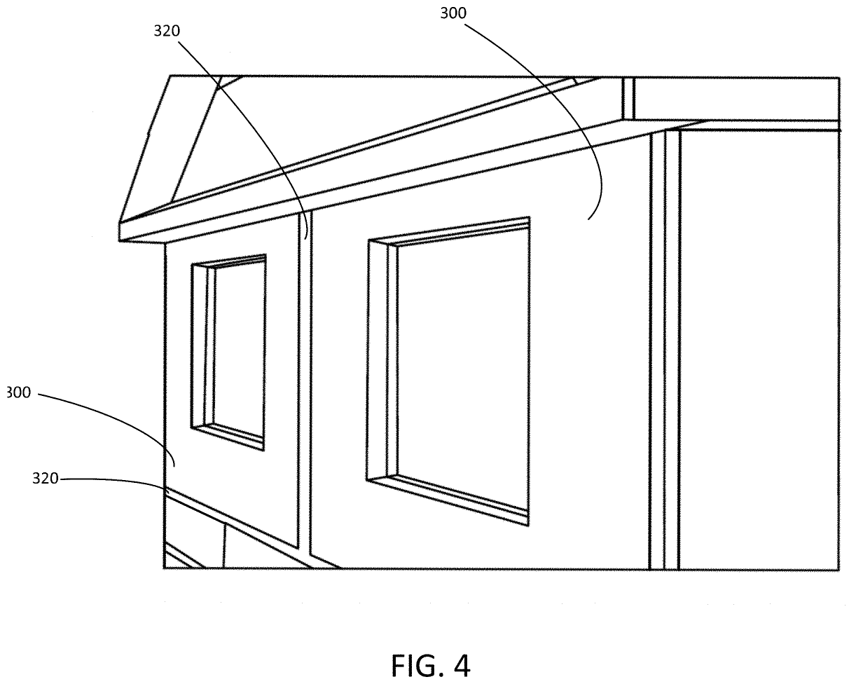

In certain embodiments, as shown in FIG. 4, a building sheathing system includes at least two gypsum panels 300 and a seaming component 320 configured to provide a seam at an interface between at least two of the gypsum panels 300. In certain embodiments, the seaming component comprises tape or a bonding material. For example, the seaming component may be a tape including solvent acrylic adhesives, a tape having a polyethylene top layer with butyl rubber adhesive, a tape having an aluminum foil top layer with butyl rubber adhesive, a tape having an EPDM top layer with butyl rubber adhesive, a tape having a polyethylene top layer with rubberized asphalt adhesive, or a tape having an aluminum foil top layer with rubberized asphalt adhesive or rubberized asphalt adhesives modified with styrene butadiene styrene. For example, the seaming component may be a bonding material containing silyl terminated polyether, silyl modified polymers, silicones, synthetic stucco plasters and/or cement plasters, synthetic acrylics, sand filled acrylics, and/or joint sealing chemistries comprising solvent based acrylics, solvent based butyls, latex (water-based, including EVA, acrylic), polysulfides polyurethanes, and latexes (water-based, including EVA, acrylic).

Thus, the above-described enhanced panels may be installed with either a tape, liquid polymer, or other suitable material, to effectively treat areas of potential water and air intrusion, such as seams, door/window openings, penetrations, roof/wall interfaces, and wall/foundation interfaces. As such, the building sheathing panels, when used in combination with a suitable seaming component, create an effective water-resistive and/or air barrier envelope.

Such building sheathing systems may advantageously pass any or all ICC-ES tests required for water resistant and air barrier system performance. For example, the sheathing systems may pass Sections 4.1, 4.2, 4.3, 4.4, 4.7, and/or 4.8 of the ICC-ES Acceptance Criteria for water-resistive coatings used as water-resistive barriers over exterior sheathing (ICC Evaluation Service Acceptance Criteria 212), dated February 2015. For example, the sheathing systems may pass Section 4.5 of the ICC-ES Acceptance Criteria for water-resistive membranes factory bonded to wood-based structural sheathing, used as water-resistive barriers (ICC Evaluation Service Acceptance Criteria 310), dated May 2008, revised June 2013.

In certain embodiments, the building sheathing system including at least two gypsum panels and a seaming component displays no water leaks when measured according ICC Evaluation Service Acceptance Criteria 212, section 4. This test uses an 8′ by 8′ wall assembly built with multiple gypsum panels and having two vertical joint treatments and one horizontal joint treatment with seaming component(s) (as described in more detail herein) and flashing treatment with seaming component(s). The wall is subjected to 10 positive transverse load cycles of ASTM E2357 (procedure A), to racking loads of ASTM E72 to obtain a net deflection of ⅛ inch with hold-downs, and then to restrained environmental conditioning cycles as described in AC 212 section 4.7.3 for two weeks. Thus, in some embodiments, the building sheathing system displays no water leaks when measured according to ICC Evaluation Service Acceptance Criteria 212, Section 4, after being subjected to the test methods of ASTM E2357 procedure A, ASTM E72, and restrained environmental conditioning. The cycled wall is then tested in ASTM E331 water penetration with a water spray of at least 8 gallons of water per minute and air pressure differential of 2.86 psf, and resulting in no leaks within the field of the panel or cracking of sheathing or seaming components.

Thus, in some embodiments, the building sheathing system displays no water leaks when measured according to ASTM E331 wall assembly test at an air pressure of 2.86 psf and/or at an air pressure of 8.58 psf. In some embodiments, the building sheathing system displays no water leaks when measured according to ASTM E331 wall assembly test at a higher air pressure, such as above 10 psf, or about 20 psf, and up to about 25 psf, for one hour. The ASTM E331 test may be a water spray after a structural test and/or a test including the building transitions, openings, and penetrations. In addition to ASTM E331, other suitable tests may be substituted, such as tests using chambers that spray or flood the exposed side of the wall or are rotated to receive bulk water and create a negative air pressure differential on the inside cavity in order to expose leaks. This may include but is not limited to ASTM E547, ASTM D5957, AAMA 501.2, or field testing apparatus such as ASTM E1105. Thus, the building sheathing systems described herein may pass any combination of the foregoing tests.

In certain embodiments, the building sheathing system displays an air penetration resistance of 0.02 L/sm2 at 75 Pa, or less, when measured according to ASTM E2178. In certain embodiments, the sheathing system displays an air penetration resistance of 0.02 L/sm2 at 300 Pa, or less, when measured according to ASTM E2178.

In certain embodiments, the building sheathing system displays an exfiltration and infiltration air leakage rate of less than 0.04 cfm/ft2 at 1.57 lbs/ft2 (75 Pa), when measured according to the ASTM E2357 air barrier assembly test for both opaque walls and walls with penetration, when 8′ by 8′ walls are prepared using seaming components to seal joints, window openings, duct penetrations, pipe penetrations, external junction boxes, and masonry ties. In some embodiments, the ASTM E2357 wall assemblies, after being is exposed to Q10>0.20 kPa pressure design value wind loads for sustained, cyclic, and gust loads display an air leakage infiltration and exfiltration rate of less than 0.04 cfm/ft2 at 6.27 lbs/ft2 (300 Pa). In certain embodiments, the building sheathing system displays an exfiltration and infiltration air leakage rate of less than 0.02 cfm/ft2 at 1.57 lbs/ft2 (75 Pa), when measured according to the ASTM E2357 air barrier assembly test for both opaque walls and walls with penetration. In addition to ASTM E 2357, other tests may be used to quantify air leakage in this range, including CAN S742, ASTM E283, ASTM E2319, ASTM E1424, ASTM E283, ASTM E1424, or similar test methods. Also, related field testing to test pressure differentials, in this range, such as ASTM E783 or related blower door apparatus testing may also be used. Thus, the building sheathing systems described herein may pass any combination of the foregoing tests.

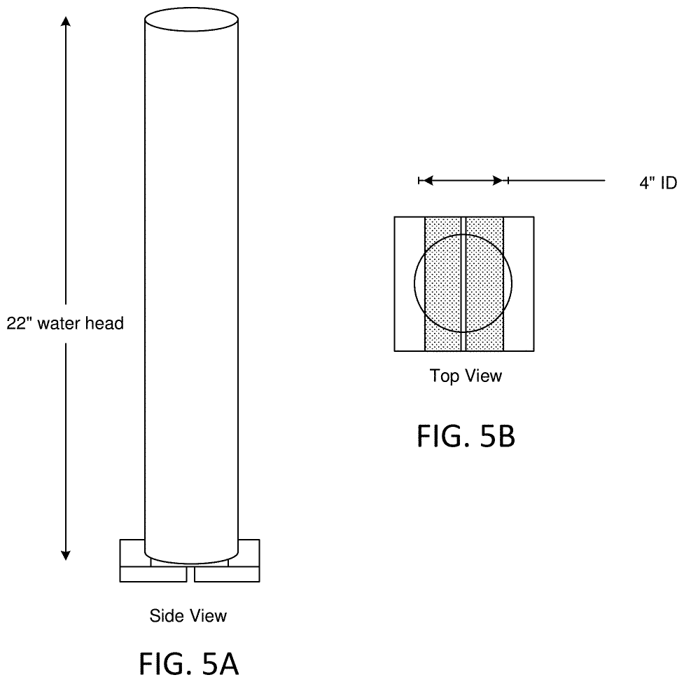

In some embodiments, the system passes a hydrostatic head test against water leakage, as measured by AATCC 127-2008, modified per AC 212 Section 4.8.3. In certain embodiments, the building sheathing system passes AATCC hydrostatic head test method 127-2008 for a 22-inch head of water (114 psf water pressure) directly over an interface of at least two gypsum panels and the seaming component, with no leaks after 5 hours, as illustrated in FIGS. 5A-5B. In addition to hydrostatic head pressure, other similar tests can be used to assess bulk water resistance in the range of 0.32 inches water (1.67 psf) to 44 inches of water head pressure (228 psf). This may include but is not limited to other water head tests (such as ASTM E2140), water ponding test, cobb tests (such as ASTM C473, ASTM D 3285, ASTM D 5795, ASTM D7433, ASTM D7281), or a chambered test aided by vacuum or negative pressure differentials. Thus, the building sheathing systems described herein may pass any combination of the foregoing tests.

In certain embodiments, the system passes AC310-2008, which tests water-resistive membranes & barriers. In some embodiments, the system passes AAMA 714 standard for liquid-applied flashing. In certain embodiments, the sheathing system has a water vapor permeance of at between 0.1 perm and 1 perm (i.e., a class II vapor permeance), when measured according to ASTM E96, in the absence of any externally applied barrier product.

Thus, in certain embodiments, the sheathing system (i) displays a vapor permeance of between 0.1 perm and 1 perm, when measured according to ASTM E96, (ii) passes a hydrostatic head test against water leakage, as measured by AATCC 127-2008, (iii) displays no water leaks when measured according to ICC Evaluation Service Acceptance Criteria 212, Section 4, after being subjected to the test methods of ASTM E2357 procedure A, ASTM E72, and restrained environmental conditioning, and/or (iv) meets the air barrier requirements set forth in ASTM E2357 or CAN S742. Therefore, the sheathing system may display certain levels of water resistive properties. Additionally, such sheathing systems may further display desired water vapor permeance, air penetration resistance, air leakage rate, and fire resistant properties. These sheathing systems therefore provide a water resistive air barrier in the absence of any externally applied barrier product, other than the seaming component. That is, no mechanically attached flexible barrier sheet material, self-adhered barrier sheet material, fluid-applied membranes, spray foam membrane, or other barrier product need be applied to the external field of the panels to achieve the water-resistive air barrier properties.

Thus, in certain embodiments, the sheathing system includes panels having a gypsum core (one or more layers, optionally including one or more slate coat layers), a fiberglass mat facer, a mat coating applied to the fiberglass mat facer, and a secondary barrier coating applied to the coated fiberglass mat facer, which panels display the water-resistive air barrier properties described herein, independent of any barrier product (e.g., mechanically attached flexible barrier sheet material, self-adhered barrier sheet material, fluid-applied membranes, spray foam membrane) being applied to the external surface of the panel during building construction.

While certain of the test methodologies described above are intended for characterizing a barrier layer alone, the assembly tests described may be conducted on the overall building panel, including any barrier layers.

### Methods

Methods of making gypsum panels having water-resistive properties are also provided. In certain embodiments, methods of making a gypsum panel include depositing a gypsum slurry onto a surface of a first fiberglass mat, and allowing the gypsum slurry to set to form a gypsum core. These methods may be used to produce gypsum panels having any of the features, or combinations of features, described herein. For example, the methods may be used to produce improved water resistance panels that provide a Class II vapor retarder.

In certain embodiments, a method includes depositing a first gypsum slurry onto a first surface of a first coated fiberglass mat; setting the first gypsum slurry to form at least a portion of a gypsum core of a gypsum panel; depositing a barrier coating onto a second surface of the first coated fiberglass mat, the second surface being a coated surface, the barrier coating containing an acrylic binder and a filler in an amount of from about 50 to about 75 percent solids by volume of the barrier coating, the barrier coating being deposited in an amount of from about 46 lb/msf to about 60 lb/msf, dry weight, wherein the gypsum panel displays a vapor permeance of between 0.1 perm and 1 perm, when measured according to ASTM E96.

The gypsum panel and its components (e.g., mat coating and barrier coating) may have any of the properties and/or characteristics described above with reference to the panels. For example, the barrier coating may contain the filler in an amount of from about 60 to about 70 percent solids by volume, such as in an amount of about 64 percent solids by volume. For example, the barrier coating may contain the filler in an amount of from about 65 percent to about 90 percent solids by weight of the barrier coating, such as from about 70 percent to about 85 percent solids by weight of the barrier coating, such as about 78 percent solids by weight of the barrier coating. In certain embodiments, the barrier coating is deposited in an amount of from about 46 lb/msf to about 58 lb/msf, such as from about 46 lb/msf to about 48 lb/msf.

In some embodiments, depositing the barrier coating involves roll coating or any other suitable application method known in the art, such as spraying, curtain coating, rolling, or brushing the coating onto the coated surface of the fiberglass mat.

In certain embodiments, methods of making gypsum panels include depositing a first gypsum slurry onto a first surface of a first fiberglass mat; allowing the first gypsum slurry to set to form at least a portion of a gypsum core; applying a mat coating comprising a polymer binder to a second surface, opposite the first surface, of the first fiberglass mat, in an amount of from about 1 lb/MSF to about 40 lb/MSF, such that the mat coating has an average thickness of from about 1 micron to about 100 microns, wherein the mat coating eliminates at least 99 percent of pin holes present in the exposed second surface of the first fiberglass mat. The mat coating may be applied in the form of any of the precursor materials described above with reference to the panels.

For example, the mat coating may be produced by depositing a continuous liquid film on the building material panels, followed by drying under heat or curing by chemicals or certain types of energy (e.g., UV light, IR radiation, thermal, electron beam). Suitable thin film deposition techniques include roll coating, knife coating, curtain coating, rod coating, spraying, brushing, dipping, transfer coating, and other techniques known in the industry. For example, the coating material may be applied by a low pressure sprayer, bar hydraulic spray nozzles, or air atomized spray. For example, the coating material may be applied in line during the panel manufacturing process (i.e., either pre-panel drying or post via a separate dryer or UV cure).

In some embodiments, the mat coating is applied to the second surface of the first fiberglass mat prior to setting of the first gypsum slurry. In other embodiments, the mat coating is applied to the second surface of the first fiberglass mat after setting of the first gypsum slurry. In some embodiments, the method also includes setting the continuous barrier coating by heat or curing.

In certain embodiments, the gypsum core includes multiple layers that are sequentially applied to the fiberglass mat, and allowed to set either sequentially or simultaneously. In other embodiments, the gypsum core includes a single layer. In some embodiments, a second fiberglass mat may be deposited onto a surface of the final gypsum slurry layer (or the sole gypsum slurry layer), to form a dual mat-faced gypsum panel. For example, the second fiberglass mat may include a barrier coating on its surface that penetrates a portion of the mat. The gypsum slurry or multiple layers thereof may be deposited on the fiberglass mat by any suitable means, such as roll coating.

In certain embodiments, depositing the gypsum slurry includes depositing a first gypsum slurry having a wet density of from about 88 pcf to about 98 pcf onto the surface of a fiberglass mat, the first gypsum slurry. In certain embodiments, the first gypsum slurry has a wet density of from about 93 pcf to about 96 pcf. In some embodiments, the gypsum core includes at least three gypsum layers, with the outermost gypsum layers of the gypsum core (i.e., the layers that form an interface with the fiberglass mats) being slate coat layers. In certain embodiments, both outermost layers have a relatively high density or are otherwise chemically altered for enhanced penetration. Thus, a third gypsum slurry may have a wet density of from about 88 pcf to about 98 pcf, or from about 93 pcf to about 96 pcf.

In certain embodiments, depositing the gypsum slurry includes depositing a first gypsum slurry containing a wetting agent, as described in more detail below. The first gypsum slurry may be the first of multiple gypsum layers deposited to form the gypsum core (i.e., a slate coat layer), or the first gypsum slurry may be the sole gypsum layer deposited to form the gypsum core. The first gypsum slurry (or both of the outermost gypsum slurries) may contain a wetting agent in an amount effective to reduce a surface tension of the first gypsum slurry to 65 dyne/cm or less, measured on the aqueous liquid after solid ingredients are filtered out. In certain embodiments, the first gypsum slurry contains a wetting agent in an amount effective to reduce a surface tension of the first gypsum slurry to 60 dyne/cm or less. In certain embodiments, the first gypsum slurry contains a wetting agent in an amount effective to reduce a surface tension of the first gypsum slurry to 55 dyne/cm or less. In certain embodiments, the first gypsum slurry includes a wetting agent in an amount effective to reduce a surface tension of the first gypsum slurry to from about 40 dyne/cm to about 65 dyne/cm. The reduced surface tension of aqueous liquid in the gypsum slurry enhances the slurry penetration into the glass mat, in reference to the pure water surface tension of 72 dyne/cm at 25° C.

In certain embodiments, the first gypsum slurry (or each of the outermost gypsum slurry layers) is deposited in an amount of from about 5 percent to about 20 percent, by weight, of the gypsum core.

In certain embodiments, the wetting agent is selected from a group consisting of surfactants, superplasticisers, dispersants, agents containing surfactants, agents containing superplasticisers, agents containing dispersants, and combinations thereof. For example, the gypsum slurry or layer(s) may include wax, wax emulsions and co-emulsions, silicone, siloxane, or a combination thereof. For example, suitable superplasticisers include Melflux 2651 F and 4930F, commercially available from BASF Corporation. In certain embodiments, the wetting agent is a surfactant having a boiling point of 200° C. or lower. In some embodiments, the surfactant has a boiling point of 150° C. or lower. In some embodiments, the surfactant has a boiling point of 110° C. or lower. For example, the surfactant may be a multifunctional agent based on acetylenic chemistry or an ethoxylated low-foam agent. Without intending to be bound by a particular, it is believed that use of a surfactant having such a low boiling or decomposition temperature encourages evaporation an thereby loss of wetting functionality during the board drying process. In particular, high Cobb (surface water absorption) was found in certain boards due to residual surfactants left in the glass mat on board surface, which promoted wetting again and increased surface water absorption. Even at higher board drying temperatures, the temperature was still not high enough to evaporate off all surfactants, and Cobb remained high. Therefore the low boiling point surfactants advantageously demonstrate increased surface evaporation and resulting low Cobb (water absorption) properties. In certain embodiments, there is no residual wetting agent present in the set gypsum core.

In certain embodiments, the surfactant is present in the first gypsum slurry in an amount of about 0.01 percent to about 1 percent, by weight. In certain embodiments, the surfactant is present in the first gypsum slurry in an amount of about 0.01 percent to about 0.5 percent, by weight. In some embodiments, the surfactant is present in the first gypsum slurry in an amount of about 0.05 percent to about 0.2 percent, by weight.

Suitable surfactants and other wetting agents may be selected from non-ionic, anionic, cationic, or zwitterionic compounds, such as alkyl sulfates, ammonium lauryl sulfate, sodium lauryl sulfate, alkyl-ether sulfates, sodium laureth sulfate, sodium myreth sulfate, docusates, dioctyl sodium sulfosuccinate, perfluorooctanesulfonate, perfluorobutanesulfonate, linear alkylbenzene sulfonates, alkyl-aryl ether phosphates, alkyl ether phosphate, alkyl carboxylates, sodium stearate, sodium lauroyl sarcosinate, carboxylate-based fluorosurfactants, perfluorononanoate, perfluorooctanoate, amines, octenidine dihydrochloride, alkyltrimethylammonium salts, cetyl trimethylammonium bromide, cetyl trimethylammonium chloride, cetylpyridinium chloride, benzalkonium chloride, benzethonium chloride, 5-Bromo-5-nitro-1,3-dioxane, dimethyldioctadecylammonium chloride, cetrimonium bromide, dioctadecyldimethylammonium bromide, sultaines, cocamidopropyl hydroxysultaine, betaines, cocamidopropyl betaine, phospholipids phosphatidylserine, phosphatidylethanolamine, phosphatidylcholine, sphingomyelins, fatty alcohols, cetyl alcohol, stearyl alcohol, cetostearyl alcohol, stearyl alcohols. oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEA, cocamide DEA, dodecyldimethylamine oxide, polyethoxylated tallow amine, and block copolymers of polyethylene glycol and polypropylene glycol. For example, suitable surfactants include Surfynol 61, commercially available from Air Products and Chemicals, Inc. (Allentown, Pa.).

In certain embodiments, the gypsum slurry (or one or more layers thereof) includes a hydrophobic additive. For example, the gypsum slurry or layer(s) may include wax, wax emulsions and co-emulsions, silicone, siloxane, silanes, or any combination thereof.

In certain embodiments, the first gypsum slurry includes, alternatively to or in addition to the surfactant, an aqueous polymer or inorganic binder to enhance penetration of the slurry into the mat. In certain embodiments, the first gypsum slurry includes the binder in an amount effective to provide from about 0.5 lb/1000 ft2 to about 50 lb/1000 ft2 binder in the set gypsum layer. In one embodiment, the first gypsum slurry includes the binder in an amount effective to provide from about 0.5 lb/1000 ft2 to about 15 lb/1000 ft2 binder in the set gypsum layer. For example, the binder may be a suitable latex binder, such as a hydrophobic modified acrylic latex binder. In one embodiment, the latex binder is one with low surface tension, such as ENCOR 300, commercially available from Arkema (France). For example, the binder may be styrene-butadiene-rubber (SBR), styrene-butadiene-styrene (SBS), ethylene-vinyl-chloride (EVC1), poly-vinylidene-chloride (PVdCl) and poly(vinylidene) copolymers, modified poly-vinyl-chloride (PVC), poly-vinyl-alcohol (PVOH), ethylene-vinyl-acetate (EVA), poly-vinyl-acetate (PVA) and polymers and copolymers containing units of acrylic acid, methacrylic acid, their esters and derivatives thereof (acrylic-type polymers), such as styrene-acrylate copolymers. In one embodiment, the binder is a hydrophobic, UV resistant polymer latex adhesive. For example, the hydrophobic, UV resistant polymer latex binder adhesive may be based on a (meth)acrylate polymer latex, wherein the (meth)acrylate polymer is a lower alkyl ester, such as a methyl, ethyl or butyl ester, of acrylic and/or methacrylic acids, and copolymers of such esters with minor amounts of other ethylenically unsaturated copolymerizable monomers (such as styrene) which are known to the art to be suitable in the preparation of UV resistant (meth)acrylic polymer latexes. In certain embodiments, the binder coating is free of filler.

In certain embodiments, the gypsum slurry (or one or more layers thereof) is substantially free of foam, honeycomb, excess water, and micelle formations. As used herein, the term “substantially free” refers to the slurry containing lower than an amount of these materials that would materially affect the performance of the panel. That is, these materials are not present in the slurry in an amount that would result in the formation of pathways for liquid water in the glass mat of a set panel, when under pressure.

In certain embodiments, alternatively to or in addition to the mat penetration enhancing gypsum layers discussed herein, the methods include depositing an aqueous polymer or inorganic binder coating onto the first (internal) surface of the first fiberglass mat, prior to depositing the gypsum slurry onto the first surface of the first fiberglass mat. For example, the binder coating may include the binder materials discussed above with reference to gypsum layer additives. In certain embodiments, the binder is a latex binder that is free of filler. In certain embodiments, the internal mat coating comprises a wetting agent in an amount effective to bring a wet surface tension of the coating to 60 dyne/cm or less. In some embodiments, the internal coating comprises a wetting agent in an amount effective to bring a wet surface tension of the coating to from about 40 dyne/cm to about 60 dyne/cm. For example, the wetting agent may be a surfactant having a boiling point of 200° C. or lower, as discussed above with reference to gypsum layer wetting agents. In certain embodiments, the surfactant is present in the aqueous coating composition for the internal mat surface in an amount of about 0.01 percent to about 0.5 percent, by weight. In some embodiments, the surfactant is present in the aqueous coating in an amount of about 0.05 percent to about 0.2 percent, by weight. In one embodiment, a binder that is a higher surface tension latex, such as NEOCAR 820, commercially available from Arkema (France), is combined with a surfactant, such as Surfynol 440, commercially available from Air Products and Chemicals, Inc. (Allentown, Pa.), to provide the desired low surface tension.

In certain embodiments, depositing the internal mat aqueous binder coating includes spraying, curtain coating, rolling, or brushing the coating onto the first surface of the first fiberglass mat. In certain embodiments, the binder is deposited onto a fibrous surface of the fiberglass mat by a roll coater, knife coater, curtain coater, wire-rod coater, spraying, or combinations thereof. In some embodiments, the method includes vacuuming excess aqueous binder from the first fiberglass mat after depositing the aqueous binder coating thereon. In certain embodiments, the method includes curing the binder coating prior to depositing the gypsum slurry onto the first surface of the first fiberglass mat. In certain embodiments, the aqueous binder coating is deposited onto the first surface of the first fiberglass mat in an amount of from about 5 g/ft2 to about 10 g/ft2, for example in an amount of about 7.7 g/ft2, on a dry basis. In certain embodiments, the aqueous binder coating is deposited onto the first surface of the first fiberglass mat in an amount of from about 0.2 g/ft2 to about 5 g/ft2, on a dry basis.

In some embodiments, the gypsum core includes at least three gypsum layers, with the outermost gypsum layers of the gypsum core (i.e., the layers that form an interface with the fiberglass mats). In certain embodiments, both outermost layers are chemically altered for enhanced penetration.

In some embodiments, the method also includes mechanically vibrating at least the first fiberglass mat having the first gypsum slurry deposited thereon to effect penetration of the gypsum slurry into the remaining fibrous portion of the first fiberglass mat. In certain embodiments, the method includes passing at least the first fiberglass mat having the first gypsum slurry deposited thereon over a vibration table. For example, a fiberglass mat having only one layer of gypsum slurry deposited thereon (such as the slate coat), or a fiberglass mat having multiple gypsum slurry layers, and optionally a second fiberglass mat opposite the first fiberglass mat, may be passed over a vibration table. In certain embodiments, the first fiberglass may and gypsum slurry are passed over the vibration table prior to the panel being passed through a forming plate. In certain embodiments, the vibration table includes at least one vibrating plate configured to display a mean vibration of from about 5 in/s to about 10 in/s. In certain embodiments, the vibration table includes at least one vibrating plate configured to vibrate at a frequency of from about 32 Hz to about 20 kHz. In some embodiments, the fiberglass mat and gypsum are passed over two sequential vibrating plates. It has been found that compared to traditional rolls having nubs thereon, the vibration tables achieve superior gypsum slurry penetration of the fiberglass mat.

In certain embodiments, the panel core slurry (or layers thereof) may be deposited on the non-coated side of a horizontally oriented moving web of pre-coated fibrous mat. A second coated or uncoated fibrous mat may be deposited onto the surface of the panel core slurry opposite the first coated fibrous mat, e.g., a non-coated surface of the second coated fibrous mat contacts the panel core slurry. In some embodiments, a moving web of a pre-coated or uncoated nonwoven fibrous mat may be placed on the upper free surface of the aqueous panel core slurry. Thus, the panel core material may be sandwiched between two fibrous mats, one or both having a mat coating. In certain embodiments, allowing the panel core material and/or mat coating to set includes curing, drying, such as in an oven or by another suitable drying mechanism, or allowing the material(s) to set at room temperature (i.e., to self-harden).

The barrier coating may be applied to one or both (in embodiments having two) coated mat surfaces, prior to or after drying of the mat coating. In some embodiments, the fiberglass mats are pre-coated when they are associated with the panel core slurry. In some embodiments, depositing the barrier coating onto the second surface of the first coated fiberglass mat occurs after setting the first gypsum slurry to form at least a portion of a gypsum core. In some embodiments, the gypsum core coated with the barrier coating is cured, dried, such as in an oven or by another suitable drying mechanism, or the materials are allowed to set at room temperature. In some embodiment, infrared heating is used to flash off water and dry the barrier coating.

Gypsum panels disclosed herein advantageously display improved surface water vapor resistance and weathering performance.

Methods of constructing a building sheathing system, as shown in FIG. 4, are also provided herein, including installing at least two gypsum panels 300 having an interface therebetween, and applying a seaming component 320 at the interface between the at least two of the gypsum panels 300. Gypsum panels used in these methods may have any of the features, properties, or combinations of features and/or properties, described herein. Sheathing systems constructed by these methods may have any of the features, properties, or combinations or features and/or properties, described herein. The seaming component may be any suitable seaming component as described herein.

### EXAMPLES

Embodiments of the water-resistive panels disclosed herein were constructed and tested, as described below.

The following experiment was conducted on DensShield® (commercially available from Georgia-Pacific) panels using various barrier coating weights to determine the feasibility of such panels as a Class II vapor retarder. DensShield® is a coated glass mat gypsum underlayment used for tile. A secondary barrier coating (a high filled acrylic coating) was applied to the coated mat surface of the standard panels. The barrier coating weighed about 13.4 lbs/gallon and contained about 64% solids by % volume of 78% solids by weight. The viscosity was about 12,000 cps with a Brookfield spindle #5 at 50 rpm. The pH was around 8.5. The barrier coating weight was increased over traditional levels to greater than about 46-48 pound/msf, which was discovered to yield a consistent permeance between 0.1 and 1.0 (i.e., Class II). In comparison, panels coated with lower amounts (i.e., less than about 45 pounds/msf) were unable to consistently meet Class II standards.

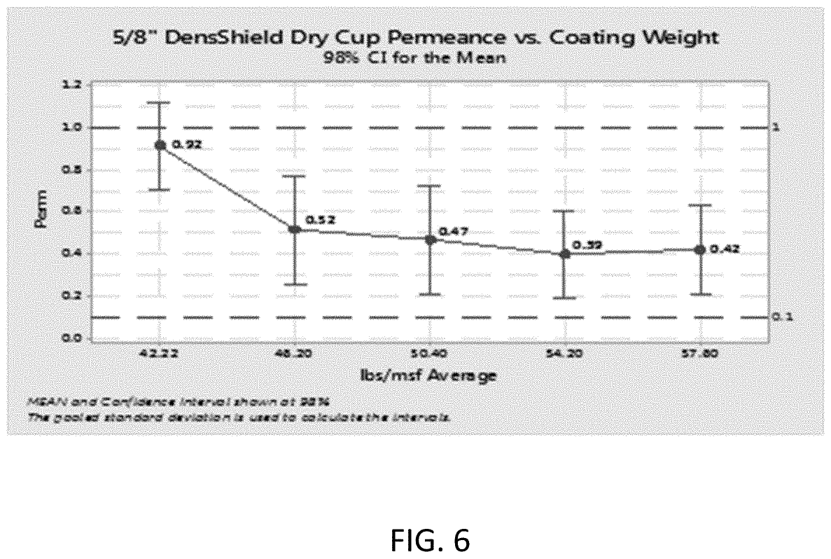

FIG. 6 shows the results of 12″×12″ samples tested for Water Vapor Transmission (dry cup method). As can be seen, only above about 46 pound/msf were Class II vapor permeance results obtained.

Next, an E331 DensShield® wall was then built at approximately 48 pound/msf barrier coating weight and subjected to E331 Water Penetration testing following E72 wall racking test. Leakage was observed to the backside of the wall along the horizontal joint during water penetration testing at around 40 seconds into test. The water penetration was associated with adhesion of the tape used to the substrate and racking stresses of the E72.

Specifically, the E331 wall construction included an 8′ by 8′ stud wall using SPF No. 2 lumber, stud spacing of 16″ on center, 1⅝″ bugle head exterior screws, fastener spacing 8″ on center field and perimeter, 8″ fastener spacing on ends, ⅝″ coated DensShield® panels constructed as described above, seams covered with 4″ Self-Adhesive Henry BlueSkin® Weather Barrier Tape (commercially available from Henry), and fastener heads spotted with Prosoco FastFlash (commercially available from Prosoco) and allowed to cure overnight.

The test wall was then subjected to Racking Test in accordance with ASTM E72 with a net deflection of 0.0125″ at 1370 lbs. force and 0.1825″ net deflection at 1540 lbs. force. Surprisingly, the Racking transverse load test showed no leakage through barrier itself. The test wall was then removed and installed in an E331 Chamber and the E331 water penetration test was run at 2.86 psf. (5.3 gal/min water flow rate). Water leakage was observed along horizontal seam (but not through the barrier/panel itself) around 40 seconds into test.

Accordingly, it was discovered that a slight increase in secondary coating weight using a highly filler loaded acrylic coating on a pre-coated fiberglass mat faced gypsum panel achieves a semi-impermeable vapor retardation. When used in a sheathing assembly, such panels retard vapor intrusion into the assembly when seams and other building structure transitions, penetrations, and openings are sealed (i.e., in the absence of an externally applied barrier product such as a membrane barrier or wrap). In particular, a Class II vapor retardation level was achieved.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of making a gypsum panel, comprising:
depositing a first gypsum slurry onto a first surface of a first coated fiberglass mat;
setting the first gypsum slurry to form at least a portion of a gypsum core of a gypsum panel; and
depositing a barrier coating onto a second surface of the first coated fiberglass mat, the second surface comprising a coated surface, the barrier coating comprising an acrylic binder and a filler in an amount of from about 50 to about 75 percent solids by volume of the barrier coating, the barrier coating being deposited in an amount of from about 46 lb/msf to about 60 lb/msf, dry weight,
wherein the gypsum panel displays a vapor permeance of between 0.1 perm and 1 perm, when measured according to ASTM E96.

2. The method of claim 1, wherein the barrier coating comprises the filler in an amount of from about 60 to about 70 percent solids by volume.

3. The method of claim 1, wherein the barrier coating comprises the filler in an amount of about 64 percent solids by volume.

4. The method of claim 1, wherein barrier coating comprises the filler in an amount of from about 65 percent to about 90 percent solids by weight of the barrier coating.

5. The method of claim 4, wherein the barrier coating comprises the filler in an amount of from about 70 percent to about 85 percent solids by weight of the barrier coating.

6. The method of claim 4, wherein the barrier coating comprises the filler in an amount of about 78 percent solids by weight of the barrier coating.

7. The method of claim 1, wherein the filler comprises calcium carbonate.

8. The method of claim 1, wherein the barrier coating is deposited in an amount of from about 46 lb/msf to about 58 lb/msf.

9. The method of claim 8, wherein the barrier coating is deposited in an amount of from about 46 lb/msf to about 48 lb/msf.

10. The method of claim 1, wherein the barrier coating has a weight of from about 13 to about 14 lbs/gallon.

11. The method of claim 1, wherein the barrier coating has a viscosity of about 10,000 to about 14,000 cps, as measured on a Brookfield spindle #5 at 50 rpm.

12. The method of claim 1, wherein depositing the barrier coating comprises roll coating.

13. The method of claim 1, wherein setting the first gypsum slurry comprises heating the first gypsum slurry deposited on the first coated fiberglass mat in an oven.

14. The method of claim 1, wherein depositing the barrier coating onto the second surface of the first coated fiberglass mat occurs after setting the first gypsum slurry to form at least a portion of a gypsum core.

15. The method of claim 1, further comprising drying the gypsum core coated with the barrier coating in an oven.

16. A gypsum panel, comprising:
a gypsum core having a first surface and a second opposed surface;
a first coated fiberglass mat associated with the first surface of the gypsum core; and
a barrier coating disposed on the first coated fiberglass mat, the barrier coating comprising an acrylic binder and a filler in an amount of from about 50 to about 75 percent solids by volume of the barrier coating, the barrier coating being deposited in an amount of from about 46 lb/msf to about 60 lb/msf, dry weight,
wherein the gypsum panel displays a vapor permeance of between 0.1 perm and 1 perm, when measured according to ASTM E96.

17. The gypsum panel of claim 16, wherein the barrier coating comprises the filler in an amount of from about 60 to about 70 percent solids by volume.

18. The gypsum panel of claim 16, wherein the barrier coating comprises the filler in an amount of about 64 percent solids by volume.

19. The gypsum panel of claim 16, wherein barrier coating comprises the filler in an amount of from about 65 percent to about 90 percent solids by weight of the barrier coating.

20. The gypsum panel of claim 19, wherein the barrier coating comprises the filler in an amount of from about 70 percent to about 85 percent solids by weight of the barrier coating.

21. The gypsum panel of claim 19, wherein the barrier coating comprises the filler in an amount of about 78 percent solids by weight of the barrier coating.

22. The gypsum panel of claim 16, wherein the filler comprises calcium carbonate.

23. The gypsum panel of claim 16, wherein the barrier coating is deposited in an amount of from about 46 lb/msf to about 58 lb/msf.

24. The gypsum panel of claim 23, wherein the barrier coating is deposited in an amount of from about 46 lb/msf to about 48 lb/msf.

25. The gypsum panel of claim 16, wherein the barrier coating has a weight of from about 13 to about 14 lbs/gallon.

26. The gypsum panel of claim 16, wherein the barrier coating has a viscosity of about 10,000 to about 14,000 cps, as measured on a Brookfield spindle #5 at 50 rpm.

27. A building sheathing system, comprising:
at least two of the gypsum panels of claim 16; and
a seaming component configured to provide a seam at an interface between the at least two gypsum panels,
wherein the system displays a vapor permeance of between 0.1 perm and 1 perm, when measured according to ASTM E96, in the absence of any externally applied barrier product.

28. The building sheathing system of claim 27, wherein the seaming component comprises tape or a bonding material.

29. The building sheathing system of claim 28, wherein the tape comprises solvent acrylic adhesives, a polyethylene top layer with butyl rubber adhesive, an aluminum foil top layer with butyl rubber adhesive, an EPDM top layer with butyl rubber adhesive, a polyethylene top layer with rubberized asphalt adhesive, or an aluminum foil top layer with rubberized asphalt adhesive or rubberized asphalt adhesives modified with styrene butadiene styrene.

30. The building sheathing system of claim 28, wherein the bonding material comprises silyl terminated polyether, silyl modified polymers, silicones, synthetic stucco plasters and/or cement plasters, synthetic acrylics, sand filled acrylics, and/or joint sealing chemistries comprising solvent based acrylics, solvent based butyls, latex (water-based, including EVA, acrylic), polysulfides polyurethanes, and latexes (water-based, including EVA, acrylic).

31. The building sheathing system of claim 27, wherein the system meets one or more of the following standards:
water penetration barrier requirements, as measured by ASTM E331, AATCC 127 modified per AC 212 Section 4.8.3; and
air barrier requirements, as measured by ASTM E2357 and CAN S742.
